(19) United States
(12) Patent Application Publication
(10) Pub. No.: US 2025/0032988 A1
(43) Pub. Date: Jan. 30, 2025

(54) ELECTROLYTE COMPOSITION CORRECTION BY ELECTRODIALYSIS

(71) Applicant: IONIC SOLUTIONS LTD., Rancho Mirage, CA (US)

(72) Inventors: Azaroghly YAZDANBOD, Calgary (CA); Nicholas Mackenzie RANDELL, Calgary (CA)

(21) Appl. No.: 18/786,507

(22) Filed: Jul. 28, 2024

Related U.S. Application Data
(60) Provisional application No. 63/529,458, filed on Jul. 28, 2023.

(51) Int. Cl. B01D 61/42; B01D 61/44; C22B 3/22; C22B 26/12

(52) U.S. Cl. CPC B01D 61/423; B01D 61/445; C22B 3/22; C22B 26/12; B01D 2311/08; B01D 2317/022; B01D 2317/025

(57) ABSTRACT

A pre-processing electrodialysis process for adjusting the proportion of constituents of mixed salt electrolytes for the production of various chemicals, or for facilitating precipitation through passing the feed through an electrodialysis cell operated with a relatively small salinity step increase, resulting in changed proportionality of constituent anions and cations in the dilute product or the concentrate product.

### CROSS REFERENCES TO RELATED APPLICATION

The present application claims the benefit of U.S. Provisional Application No. 63/529,458 filed Jul. 28, 2023, the entire disclosure of which is hereby incorporated by reference.

### FIELD OF THE INVENTION

The present invention generally relates to using electrodialysis technology to change the proportional composition of various cations and anions present in mixed salt solutions, and more specifically to the use of pre-processing electrodialysis cells to preferentially change the proportion of various ions in the dilute and the concentrate products from a feed solution to facilitate other chemical processes.

### BACKGROUND OF THE INVENTION

In many industrial processes there is a need to change or “correct” the proportionality of specific ions in an electrolyte solution, or a desire to concentrate specific electrolyte solutions in preparation for other chemical reactions. There may also be a need to prepare for direct or chemically induced selective precipitation of specific compounds present in the base solution that would be facilitated if the proportion and content of specific ions or group of ions is adjusted. Concentrating such solutions may be done by extraction of water from the solutions, using such techniques as evaporation or reverse osmosis. However, evaporation requires high energy input, and such systems are highly prone to corrosion. Reverse osmosis also has its limits, because the required operating pressures to overcome the required osmotic pressure for a high salinity feed or product solution can be prohibitive. Neither of these processes measurably adjust the proportion of ions present in a product concentrate compared to the feed.

Another means for obtaining a more concentrated solution is with electrodialysis technology. In electrodialysis typically a starting aqueous “feed solution” is provided to the electrodialysis cell, and the feed solution is then divided into two streams as the electrodialysis cell moves the dissolved ions from one feed stream to the other, forming a more concentrated solution (i.e. a “concentrate” stream) while the other stream becomes more diluted (i.e. a “dilute” stream).

In electrodialysis, ion selective membranes are used to separate the dissolved ions under the driving force of an electrical potential difference, generating an electric field transversely passing through the cell. Pairs of semi-permeable membranes which alternate as cationic and anionic ion exchange membranes are arranged within the cell, and these multiple, paired compartments are typically arranged into a configuration known in the art as a “stack”, made of alternating anion-selective and cation-selective membranes, often separated from one another by spacers positioned between adjacent membranes facilitating the flow of feed solutions between membranes, as is well known.

Accordingly, electrodialysis cells generally include the combination of a stack, a pair of electrodes each housed in an endplate (each on one side of the stack), a DC power supply, and input and output fluid flow channels/passages. When an electrical potential difference is applied between the two electrodes, positively charged cations in the feed stream move toward the cathode. These ions can easily pass through the cation exchange membranes but are retained by the anion exchange membranes. Similarly, negatively charged anions migrate towards the anode, pass through the anion exchange membranes and are retained by the cation exchange membranes. Because of the arrangement of the ion-selective membranes, the migrating ions become concentrated in each alternate compartment in the stack leaving the feed solutions in the other compartments diluted. Thus, ions removed from the aqueous feed solution are moved through a series of “dilute” compartments alternating with “concentrate” compartments, which are formed within the device upon passage of the electric current therethrough. Product solutions (either dilute product or concentrate product) can then be selectively removed.

Despite the major savings in terms of energy consumption, capital and operating costs achievable with the use of electrodialysis systems to concentrate various electrolyte solutions, achieving very high concentration concentrates often needed for such processes as precipitation of a given more valuable ion species has proven to be rather difficult. This is principally due to the observed fact that as the concentration of the concentrate formed in electrodialysis cells increases, the permselectivity of the ion selective membranes drops, in turn resulting in a reduction in current efficiency. Permselectivity is a measure of the ability of a membrane to differentiate between anions and cations. This means that as the concentration of the concentrate increases, progressively higher currents are needed to transfer ions from the diluting solutions into the concentrating solutions. In practice, this means that for each given feed electrolyte composition and salinity level, there is a practical achievable concentration level beyond which the energy input and the results obtained could not be deemed as justifiable.

Further, the Selectivity of the ion selective membranes used often leads to preferential transfer of one or several ionic species over others. Here, Selectivity is defined as the ability of an electrolyte or an ion exchange membrane to preferentially transfer one ionic species over another having the same polarity. As an example, if sodium cations (Na⁺) pass more easily than lithium ions through a cation exchange membrane, then we can say that this exchange membrane is more selective to sodium ions compared to lithium ions. For a solution of sodium and lithium salts containing sodium ions (Na⁺) and lithium ions (Li⁺), the Selectivity across a cation exchange membrane can be defined as:

$$S = [ ( {Na}_{conc} - {Na}_{feed )} ⋆ {Li}_{feed} ] / [ ( {Li}_{conc} - {Li}_{feed} ) ⋆ - {Na}_{feed} ] \qquad ( Eq . l )$$

Where Na_{cone} and Na_{feed} are the sodium ion concentration in the concentrate product and the feed solution, respectively, and Li_{cone} and Li_{feed} are the lithium-ion concentration in the concentrate and the feed, respectively. Rearranging the terms and designating the change in concentrations from the feed solution to concentrate product with the symbol Δ results in:

$$Δ Na = S ⋆ Δ Li ⋆ ( {Na}_{feed} / {Li}_{feed} ) \qquad ( Eq . 2 )$$

As a non-limiting example, consider a feed solution containing both sodium ions (Na⁺) and lithium ions (Li⁺). If the sodium ion concentration is four times that of the lithium ions, and if during electrodialysis the lithium ion concentration increases by 3,000 ppm in the concentrate compartments with respect to the feed solution, and if the selectivity “S” of the cation exchange membranes is equal to 1.5, then the sodium ion concentration increases by 18,000 ppm (ΔNa=1.5*3000*4=18000) in the concentrate compartments with respect to the feed solution. This value indicates that, under these conditions, six times more sodium ions by mass than lithium ions would be moved into the concentrate compartments from the feed solution during electrodialysis. When the target ionic species desired is lithium, this Selectivity, which typically also decreases with higher concentration ratio between the concentrate and the feed, would be undesirable. This is a typical problem in Direct Lithium Extraction (DLE) projects that typically produce eluates with higher sodium to lithium ratios typically between 3 to 6 that would then need to be concentrated to allow for precipitation of the lithium as lithium carbonate by addition of sodium carbonate. The higher the lithium content of the concentrate is, the higher the efficiency of this precipitation process will be. This also means that the higher the proportion of lithium to other cations in the concentrate, the lower the required concentration of the concentrate will be. This is true for any concentration process including reverse osmosis, evaporation and electrodialysis.

However, if the proportionality of sodium ions in the feed solution can be adjusted to two times that of the lithium ions, then a lithium ion increase by 3,000 ppm in the concentrate compartments with respect to the feed solution, and having the same Selectivity value of 1.5, will result in a concentration increase in sodium ions by 9,000 ppm in the concentrate compartments with respect to the feed solution. Having only three times as many sodium ions compared to lithium ions in the concentrate compartments, rather than six times as many as described above, is far more desirable when the desired target ion is lithium. FIG. 1 presents the results of Selectivity values calculated for a number of electrodialysis experiments on a number of synthetic eluates principally composed of a mixture of chlorides of sodium, lithium, potassium, calcium, and magnesium, which were conducted using differing starting concentrations of ions in the feed solution. These results indicate that, as the concentration ratio (total dissolved salts of the concentrate over total dissolved salts of the feed in ppm/ppm) increases, the Selectivity decreases.

In light of the above discussion, it would be beneficial to provide a means to preferentially alter the ratio of different ion species having the same polarity in a feed solution, so that a more desirable ratio for a target ion can be achieved when such solutions are concentrated or subjected to any other secondary processes.

### SUMMARY OF THE INVENTION

Accordingly, a first aspect of the invention provides a process for adjusting the proportionality of differing ionic species in a feed solution, the process comprising: (a) passing a feed solution through a pre-processing electrodialysis cell, wherein differing ionic species in the feed solution have differing ion mobilities, to create a dilute product and a concentrate product, wherein each of the dilute product and the concentrate product have an altered proportionality of the differing ionic species than the feed solution; and (b) passing one of either the dilute product or the concentrate product from the pre-processed feed solution through a main electrodialysis cell for providing a desirable target concentration for one of the differing ionic species.

A second aspect of the invention provides an electrodialysis process for altering the proportion of Lithium in a feed solution predominantly containing Lithium and Sodium ions, the process comprising: (a) passing the feed solution through a pre-processing electrodialysis cell, wherein the Lithium and Sodium ions in the feed solution have differing ion mobilities, to create a dilute product and a concentrate product, wherein each of the dilute product and the concentrate product have an altered proportionality of the Lithium and Sodium ions in the feed solution; and (b) passing the dilute product from the pre-processed feed solution through a main electrodialysis cell for providing a desirable target concentration for Lithium ions and returning the concentrate for reprocessing to the beginning of the DLE process.

The nature and advantages of the present invention will be more fully appreciated from the following drawings, detailed description, and claims.

### BRIEF DESCRIPTION OF THE DRAWINGS

The accompanying drawings illustrate embodiments of the invention and, together with a general description of the invention given above, and the detailed description given below, explain the principles of the invention.

FIG. 1 illustrates the results of Membrane Selectivity vs. concentration ratio for variable feed concentrations of mixed salt solutions containing lithium and sodium chlorides;

FIG. 2 presents the variation of sodium and lithium content of test feed 1 as a function of concentrate concentrations;

FIG. 3 presents the variation of sodium and lithium content of test feed 1 as a function of dilute concentrations;

FIG. 4 presents the variation of sodium and lithium content of test feed 2 as a function of concentrate concentrations;

FIG. 5 presents the variation of sodium and lithium content of test feed 1 as a function of dilute concentrations;

FIG. 6 presents the variation Na/Li ratio as a function of concentration/dilution ratios for test feeds 1 and 2;

FIG. 7 shows the variation of selectivity for test feed 1 and 2 as function of concentration ratio.

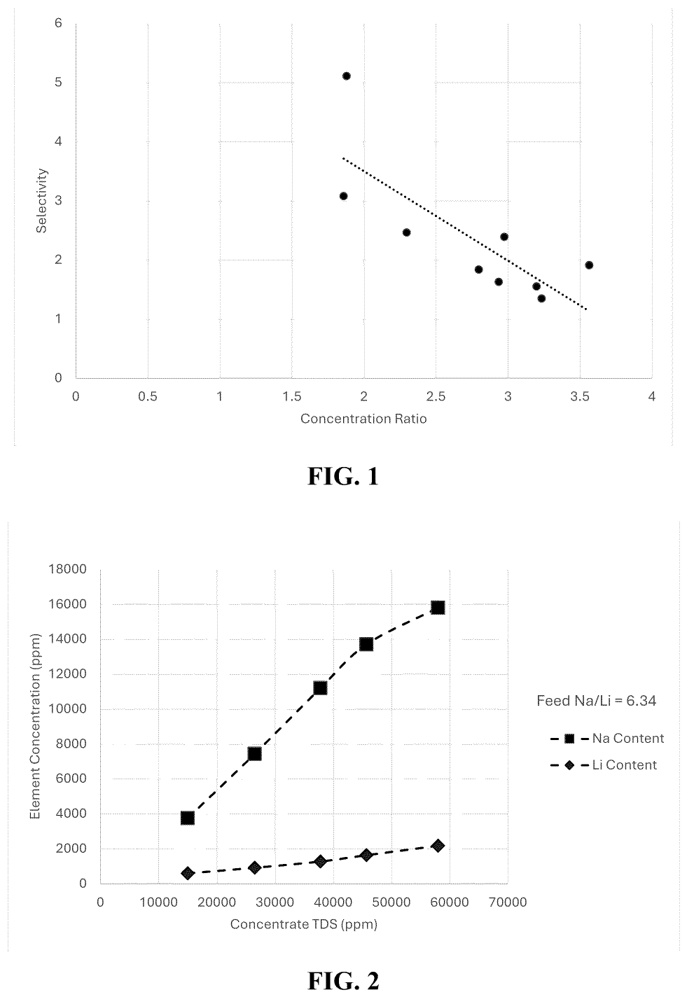

### DETAILED DESCRIPTION OF THE INVENTION

Definitions—As defined herein, the terms “ion” or “ions” refer to an atom or molecule with a net electric charge due to the loss or gain of one or more electrons. In electrolytes, ions are hydrated ions which means that they are covered by a shell of water molecules. The amount of charge of an ion depends on the number of electrons lost or gained. The terms “electrolyte” and “electrolyte solution”, “salt water”, and “water” in the context used herein are interchangeable. The principles disclosed herein are therefore applicable to any solute or chemically defined salt or salt mixture dissolved in any polar liquid, wherein the result is the formation of an electrolyte solution. Therefore, when referring to ion-containing or salty solutions, or water irrespective of the variety and concentration of the salts present in unit volume of the liquid, it is to be interpreted as to mean and include an electrolyte solution.

The terms “ion exchange membrane” and “ion selective membrane” refer to semi-permeable membranes which can function as either cation-selective or anion-selective membranes; such terms are interchangeable when used in this document.

The term “ion mobility” refers to the drift velocity of specific ions moving through a specific medium (e.g. a solution or a membrane) under the influence of an electric field. In typical units of m²*volt⁻¹*sec^{-1.} Or (meter/sec)/(volt/meter).

Description—The present invention improves the proportionality of differing ionic constituents of mixed salt electrolytes in solution by subjecting such solutions to a controlled electrodialysis process. This process envisions that if a given electrolyte of a mixture of salts has undesirable proportions of various anions or cations as an end product, such as the feed solution for a desired chemical or precipitation process, or if processing this given feed solution by electrodialysis systems would result in undesirable proportionality of these ions in the dilute product or the concentrate product, then preprocessing of these feed solutions through a controlled concentration step using electrodialysis could correct the undesirable proportionality of the ionic species in the dilute product and/or concentrate product.

The inventive process is based on the observation that differing ionic species, such as anions and cations present in a mixed salt electrolyte solution, or feed solution, placed under an electric field in an electrodialysis cell, typically have differing ion mobilities as they move through the electrolyte solution or pass through ion exchange membranes. Therefore, these differing ionic species, having differing ion mobilities, can pass through the bulk solution and through the ion exchange membranes of an electrodialysis cell at different rates, resulting in rather high Selectivity between differing ions having the same polarity. Thus, a “target” ion species or a selection of ions, having the same polarity but a lower mobility than another ion species, will not move into the concentrate compartments at the same rate as of the other ion species having the same polarity but higher mobility, such that desirable ion concentrations in the concentrate compartment of the target ion would be lower than desired. This also applies to ions that because of their lower mobilities are retained in the dilute compartments. Therefore, it is proposed herein that a pre-processing electrodialysis cell can be used to correct for the proportionality of these ions in the starting feed solution, such that when processed through the main electrodialysis system (or used in other processes) the concentrate product (and/or the dilute product) can have more desirable target ion concentrations and proportionalities with respect to other ions.

One example of the commercial use of electrodialysis cells for the concentration of industrial electrolytes is the concentration of eluates produced in Direct Lithium Extraction, or DLE. In this process, very high salinity, and predominately sodium chloride brines, typically containing only about 200 to 300 ppm of lithium, are processed through specific ion exchange resin columns. This typically results in solutions having a total dissolved solids (TDS) of above 10,000 ppm to 20,000 ppm, typically also containing about 900 ppm to about 1200 ppm of lithium. If the TDS of the eluate produced is assumed to be 17000 ppm, and if theoretically it is assumed to contain only sodium and lithium cations and if the Na/Li ratio of sodium ions (Na⁺) to lithium ions (Li⁺) in this eluate is equal to 4, then the lithium and sodium content of this solution would be 1,046.5 ppm and 4,186 ppm, respectively. Concentrating this eluate using a pre-processing electrodialysis cell as proposed herein to a concentration of 40,000 ppm, with a membrane selectivity of 1.5 and a concentrate recovery of 32.5%, will yield a concentrate stream containing about 2125 ppm of lithium and 10655 ppm of sodium. The Na/Li ratio in this concentrate stream would then be equal to 5.01. Under the same operation, the dilute stream would then contain 1072 ppm of sodium ions and 527 ppm of lithium ions. This means that the Na/Li ratio in the dilute product would be 2.03, and the TDS of the mixture of lithium chloride and sodium chloride in the dilute compartments would be about 5928 ppm.

However, if the dilute stream from the pre-processing step above is used as the feed solution in a similar electrodialysis process, so that the TDS of the resulting concentrate would again be 40,000 ppm with a concentrate recovery of 10%, then the concentrate would have 3202 ppm of lithium and 8083 ppm of sodium. This will render a Na/Li ratio of 2.52, and the concentration of the lithium product would be 51% higher than before. As a result, the concentrate product would have a much higher concentration of the “target” lithium ions.

Test Equipment and process: The electrodialysis system used consisted of an electrodialysis cell having 40 cation exchange membranes and 41 anion exchange membranes. All membranes were FUJIFILM's type 12 membranes, each with a net area of 85.5 cm². The spacers used were 0.35 mm thick. The electrodialysis cell was equipped with capacitive electrodes, (please refer to U.S. Pat. No. 8,715,477 by the same inventor, Yazdanbod) allowing it to be operated in the well-known Electrodialysis Reversal (EDR) mode with reversal time of 40 minutes. In each reversal, the dilute and the concentrate feeds and dilute and concentrate product lines were reversed using a set of four three-way valves, two on feed lines and two on output lines as is well known by practitioners of this art. A DC power supply capable of polarity reversal was used to power the cell in a current control mode. In each test the product solutions were returned to the feed container, such that the feed solution was unchanged for the duration of the tests.

In the first test, the cell was operated at currents of 0.5, 1.0, 1.5 and 2.0 Amps. This test was carried out with a feed flow of 250 ml/min with a concentrate recovery of 90%. In the second test, currents of 1.0 and 1.2 Amps were imposed for a feed flow rate ranging from 240 to 350 ml/min with recoveries ranging from 75% to 79%. In each test, after stabilization of the product salinities, verified by electrical conductivity measurements, samples were recovered from both output solutions and were sent to a lab for chemical analysis.

Test solutions: Two different feed solutions were tested. The first feed solution was an eluate generated by a DLE company with a laboratory reported TDS of 15,000 ppm. The second feed solution had a laboratory reported TDS of 13,600 ppm and was prepared using lab grade lithium chloride and common salt. Table 1 summarizes the lab reported compositions for these feed solutions.

TABLE 1

| | | | | | | Other |
|---|---|---|---|---|---|---|
| | TDS | Na | Li | Cl | Na/Li | elements |
| Feed | ppm | ppm | PPM | ppm | ppm/ppm | ppm |
| Feed 1 | 15000 | 3750 | 591 | 9750 | 6.35 | 909 |
| Feed 2 | 13600 | 2330 | 1120 | 9550 | 2.08 | 600 |

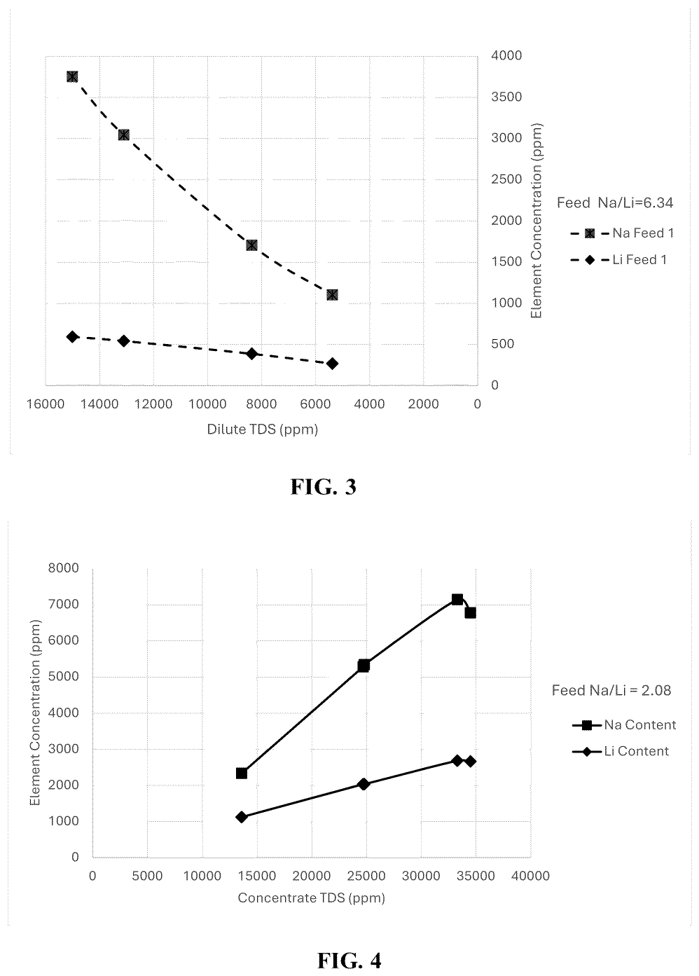

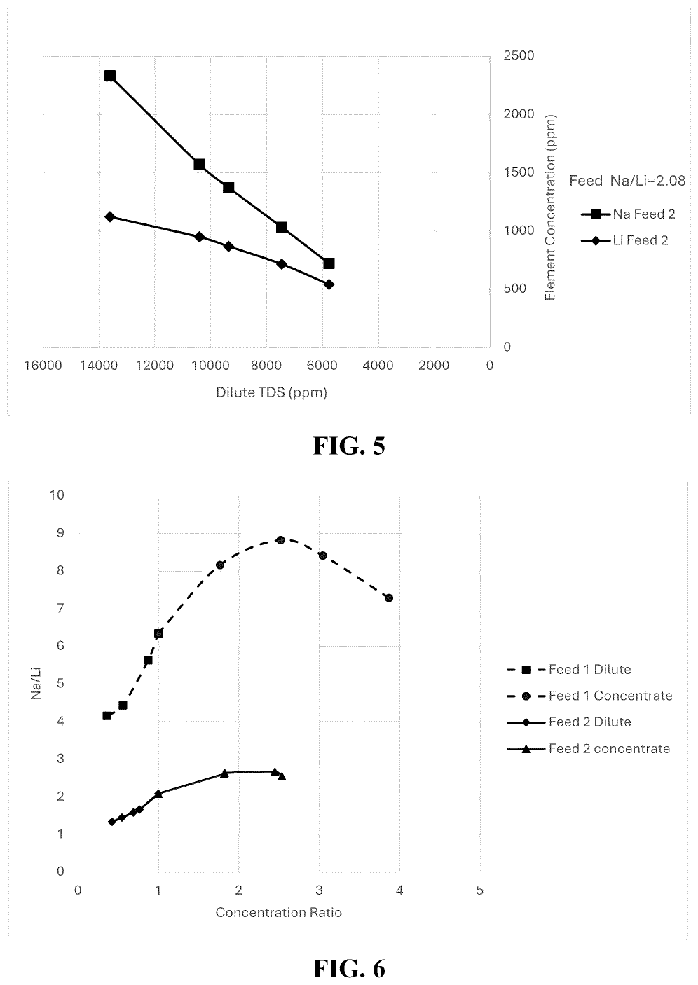

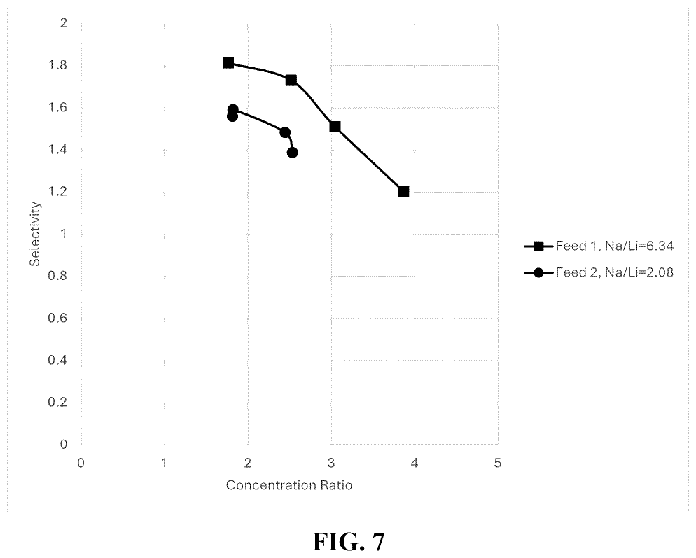

FIG. 2 and FIG. 3 present the results of an electrodialysis which processed the first feed solution, in which the variations of the sodium and lithium contents are plotted against the TDS values for the concentrate product and the dilute product respectively. These figures show that, when concentrated, the increase in sodium content is far more than the increase in lithium content. In addition, when considering the dilute product, the rate of reduction in sodium content is more than the rate of reduction in lithium. The same data for the second feed solution test are presented in FIG. 4 and FIG. 5, also showing the same trends. FIG. 6 summarizes the data in FIGS. 2-5 in terms of Na/Li ratio against concentration/dilution ratios, both for the dilute and the concentrate products. FIG. 7 presents the variations of selectivity for both test data sets against concentration ratio.

All these data show that electrodialysis processes can be used to change the proportion of various ions in the dilute and the concentrate products. If for example the goal is to achieve higher ratio of concentration of lithium with respect to sodium from a given solution made up of lithium and sodium cations and related anions, this solution could be processed in a controlled electrodialysis operation with set target recovery and dilute and/or concentrate target TDS values resulting in lower ratio of sodium with respect to lithium in the dilute product and higher ratio of the same in the concentrate product. In this case, if this formed dilute is concentrated using electrodialysis or other methods, much higher concentrations of lithium can be obtained at lower TDS of this new concentrate compared to concentration of the original feed. The concentrate can also be returned to the beginning of the DLE process for reprocessing.

evaporation option of electrodialysis concentration of the same feed as feed 2 presented here, while accounting for the Selectivity, indicates that when this solution with a TDS of 13600 is directly concentrated using electrodialysis to a TDS of 105,000 ppm, the lithium content would be about 6,600 ppm, while if the same concentration is achieved by evaporation the lithium content at best would be about 8,650 ppm. However, if the generated dilute from an electrodialysis process that generates a concentrate of 33,300 ppm (one of the data points from test 2) is concentrated to the same concentration in two 105,000 ppm, the lithium content would be close to 13,100 ppm. This shows that pre-processing of such feeds using a controlled electrodialysis operation, followed by concentration of the pre-processing dilute product can result in much higher concentration of the target lithium ions.

Given the fact that the mobility of barium ions is higher than strontium ions, which is higher than calcium ions, which is higher than magnesium ions, which is higher than copper and zinc and nickel ions, that are higher than potassium ions, which is higher than sodium ions, which is higher than lithium ions, and given the fact that the mobility of iodine ions is higher than nitrate ions, which is higher than chlorine ions, which is higher than sulfate ions, which is higher than fluoride and selenium ions, the differing mobilities could be used under this invention to adjust the content of these ions in dilute and/or concentrate product, formed from base solutions containing differing contents of such ions by electrodialysis, to obtain the desired compositions.

As an example, and given the sequence of ion mobilities noted above, let us assume that a base solution of nickel and sodium sulfates needs to processed such that the nickel could be recovered. Given the fact that nickel has a higher mobility than sodium, this base solution could be processed using an electrodialysis system, resulting in a concentrate that would have a higher proportion of nickel to sodium compared to the feed solution. This process could be designed such that in one or several steps, the final product would contain much higher purity of nickel. Alternatively, if there is a solution containing mixtures of sodium chloride, sodium sulfate, nickel chloride and nickel sulfates, and if the target is nickel chloride, then when concentrated using the process of this invention by passing this feed through an electrodialysis system, the resulting concentrate would have a much higher proportional content of nickel chloride than sodium chloride and nickel sulfate and sodium sulfate.

While the present invention has been illustrated by the description of embodiments and examples thereof, it is not intended to restrict or in any way limit the scope of the appended claims to such details. Additional advantages and modifications will be readily apparent to those skilled in the art. Accordingly, departures may be made from such details without departing from the scope of the invention.

What is claimed is:

1. A process for adjusting the proportionality of differing ionic species in a feed solution, the process comprising:
(a) passing a feed solution through a pre-processing electrodialysis cell, wherein differing ionic species in the feed solution have differing ion mobilities, to create a dilute product and a concentrate product, wherein each of the dilute product and the concentrate product have an altered proportionality of the differing ionic species than the feed solution; and
(b) passing one of either the dilute product or the concentrate product from the pre-processed feed solution through a main electrodialysis cell for providing a desirable target concentration for one of the differing ionic species.

2. The process of claim 1, wherein the proportionality of a first ionic species, the first ionic species having a lower mobility with respect to the remaining ionic species in the feed solution, is adjusted by retaining a large proportion of the first ionic species having a lower mobility in the dilute product.

3. The process of claim 2, wherein the first ionic species can be a single ion species, or a group of ion species.

4. The process of claim 2, wherein the first ionic species is Lithium.

5. The process of claim 1, wherein the proportionality of a second ionic species, the second ionic species having a higher mobility with respect to the other remaining ionic species in the feed solution, is adjusted by moving a large proportion of the second ionic species having a higher mobility to the concentrate product.

6. The process of claim 5, wherein the second ionic species can be a single ion species, or a group of ion species.

7. The process of claim 5, wherein the second ionic species is Sodium.

8. An electrodialysis process for altering the proportion of Lithium in a feed solution containing Lithium and predominantly Sodium ions, the process comprising:
a) passing the feed solution through a pre-processing electrodialysis cell, wherein the Lithium and Sodium ions in the feed solution have differing ion mobilities, to create a dilute product and a concentrate product, wherein each of the dilute product and the concentrate product have an altered proportionality of the Lithium and Sodium ions in the feed solution; and
b) passing the dilute product from the pre-processed feed solution through a main electrodialysis cell for providing a desirable target concentration for Lithium ions.

9. The process of claim 8, wherein the proportionality of Lithium, which has a lower mobility with respect to Sodium in the feed solution, is adjusted by retaining a large proportion of Lithium in the dilute product.

10. The process of claim 8, wherein the concentrate product is returned to the feed stream for reprocessing at the beginning of the process.
